(19) United States
(12) Patent Application Publication
(10) Pub. No.: US 2026/0181095 A1
(43) Pub. Date: Jun. 25, 2026

(54) METHODS AND PRINTING SYSTEM FOR OPTIMIZING RENDERING OPERATIONS

(71) Applicant: Kyocera Document Solutions Inc., Osaka (JP)

(72) Inventor: Javier A. MORALES, Rochester, NY (US)

(73) Assignee: Kyocera Document Solutions Inc., Osaka (JP)

(21) Appl. No.: 18/987,034

(22) Filed: Dec. 19, 2024

(51) Int. Cl. H04N 1/32; H04N 1/40; H04N 1/60

(52) U.S. Cl. CPC H04N 1/32448; H04N 1/40068; H04N 1/60

(57) ABSTRACT

A printing system includes a printing device having a raster image processing (RIP) system. The printing device includes a controller to implement the RIP system. A manager of the RIP system configures RIP instances to process jobs. The rendering process uses an amount of memory. If the process uses too much memory, then the rendering may fail. An adjustment is implemented by the RIP system to reduce the amount of memory used to render the pages of the job.

### FIELD OF THE INVENTION

The present invention relates to methods to optimize rendering operations used in printing operations. More particularly, the present invention relates to methods for rendering a page after it fails to render.

### DESCRIPTION OF THE RELATED ART

Pages may fail to render during printing operations. A failed page may be addressed in various manners. These adjustments, however, may take time away from printing the failed page with the document. In a print job having several hundreds or even thousands of pages, this delay may be considerable.

### SUMMARY OF THE INVENTION

A method for managing printing operations is disclosed. The method includes receiving a job at a raster image processing (RIP) system. The method also includes determining the job fails during a rendering operation at the RIP system due to insufficient memory available to the RIP system. The method also includes downscaling at least one image within the job. The method also includes adjusting the job based on the downscaled at least one image. The method also includes rendering the job at the RIP system. The method also includes upscaling that at least one image within the job.

In additional embodiments, the method also includes rendering the at least one image at a lower resolution than another object within the job.

In some embodiments, the job may include a job file having a file size. The downscaling may reduce the file size of the job file. In some embodiments, the step of determining the job fails may include determining that a page with the job fails during the rendering operation at the RIP system. The step of downscaling the at least one image may include downscaling the at least one image in the page.

In additional embodiments, the method also includes sending the rendered job with the upscaled at least one image to a print engine of the printing device. In some embodiments, the step of determining the job fails during the rendering operation may include applying a trained machine learning model to the job to determine whether the job will fail to render.

A method for managing printing operations is disclosed. The method includes receiving a job at a raster image processing (RIP) system. The method also includes determining the job fails during a rendering operation at the RIP system. The method also includes modifying a color conversion process within at least one RIP of the RIP system for at least one image within the job. The modified color conversion process uses a reduced amount of a memory available to the RIP system. The method also includes rendering the job with the at least one RIP using the modified color conversion process.

In some embodiments, the step of determining the job fails during the rendering operation may include applying a trained machine learning model to the job to determine whether the job will fail to render.

In additional embodiments, the method also includes determining that the at least one image is above a specified data size or above a specified resolution. The method also may include determining that at least one smaller image is below the specified data size or below the specified resolution. The at least one smaller image may not be rendered using the modified color conversion process.

In additional embodiments, the method also includes determining that a number of the at least one image is above a specified amount. In some embodiments, the modified color conversion process may be a one-step color conversion process.

A method for managing printing operations is disclosed. The method includes receiving a job at a raster image processing (RIP) system. The method also includes determining the job fails during a rendering operation at the RIP system. The method also includes increasing a vector flatness level within at least one RIP of the RIP system for at least one image within the job. The increased vector flatness level uses a reduced amount of a memory available to the RIP system. The method also includes rendering the job with the at least one RIP using the increased vector flatness level.

In some embodiments, the step of determining the job fails during the rendering operation may include applying a trained machine learning model to the job to determine whether the job will fail to render. In some embodiments, the increased vector flatness level may reduce the number of lines to render an image within the job.

In additional embodiments, the method also determines that at least one image of the job is above a specified data size or above a specified resolution. In additional embodiments, the method also, if the job fails to render using the increased vector flatness level, may further increase the vector flatness level. In additional embodiments, the method also sends the rendered job to a print engine of the printing device.

### BRIEF DESCRIPTION OF THE DRAWINGS

Various other features and attendant advantages of the present invention will be more fully appreciated when considered in conjunction with the accompanying drawings.

FIG. 1 illustrates a printing system for managing jobs according to the disclosed embodiments.

FIG. 2 illustrates a block diagram of components of the printing device for use within the printing system according to the disclosed embodiments.

FIG. 3 illustrates a block diagram of a RIP system for use in processing a job in the printing system according to the disclosed embodiments.

FIG. 4 illustrates a block diagram of an example RIP used within the RIP system according to the disclosed embodiments.

FIG. 5 illustrates a block diagram of a manager of the RIP system configuring a RIP instance according to the disclosed embodiments.

FIG. 6 illustrates a process flow diagram for adjusting a RIP to render a job according to the disclosed embodiments.

FIG. 7 illustrates a flow diagram for adjusting processing of images in one or more failed pages as an adjustment according to the disclosed embodiments.

FIG. 8 illustrates a flow diagram for adjusting the processing of the color conversion of one or more failed pages as an adjustment according to the disclosed embodiments.

FIG. 9 illustrates a flow diagram for adjusting the vector level flatness used in processing of one or more failed pages as an adjustment according to the disclosed embodiments.

FIG. 10 illustrates a block diagram of a supervised learning pipeline for a neural network model to determine whether an adjustment is implemented according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a fallback mechanism that may be applied to pages that fail to render due to insufficient memory resources. In some embodiments, the processes may proceed as disclosed below. Jobs are received within a printing system and processed normally. If a job fails due to insufficient memory, then the printing system may reconfigure the RIP instance that the job was using in order to reduce the memory requirements. Depending on the reconfiguration, this process may involve launching a new RIP.

In some instances, however, this sort of reconfiguration may not require the relaunching of the RIP. Instead, the pages that fail are resubmitted with the same RIP. The RIP system specifies that these pages are processed in a manner that requires less memory but at the expense of less quality output. The RIP system may reconfigure the rendering process in several ways. In some embodiments, images may be downscaled before they are rendered. Alternatively, images may be rendered to a lower resolution as opposed to the rest of the job. The images would be upscaled before they are sent to the print engine. This action may occur after rendering, which may reduce overall memory requirements to process the job. This feature would be helpful for images that have excessively high resolution and fail to render due to insufficient memory.

In some embodiments, color conversion may be changed from a two-step color conversion into a one-step color conversion in order to reduce required memory. A two-step color conversion may be a process in which colors are converted from source to profile connection space (PCS) and then from the PCS to destination. A one-step color conversion may be a process in which these color conversions are merged into a single color conversion. In some embodiments, this feature may be done only for images that are either large or which have an unusually high resolution. This feature also may be performed for smaller images if there is a large number of these images.

In other embodiments, the vector flatness level may be increased. This feature may change how many straight lines are used to render a curve. RIPs may render with many very short lines in order to render curves with a good appearance, thereby increasing the flatness. An increase in flatness reduces the number of lines that may degrade appearance but also reduces memory requirements. This feature may be limited to images or objects that have a large number of vector and text objects.

After adjusting the RIP, the RIP system would render for a second time. The RIP system may perform modest changes to the resolution and flatness settings in order to preserve as much of the expected appearance as possible. If the job still fails with the updated changes, then the RIP system may make more drastic changes and reattempt processing the job until the job processes without failing. This feature also may include having the settings reaching a defined upper limit via the adjustments.

In alternative embodiments, the system may perform a preflight on the document in order to preemptively determine whether these adjustments should be performed before attempting to render a page at all. The disclosed embodiments may include machine learning functionality in order to better correlate preflight results for each page with the need to perform specific adjustments to the RIPs before rendering a given page. A machine learning model may be implemented. The machine learning model may be continually trained based on rendering failures and subsequent successes after adjusting the settings. The machine learning model would learn not only which settings to change in order to render pages successfully but also how much the settings should be adjusted.

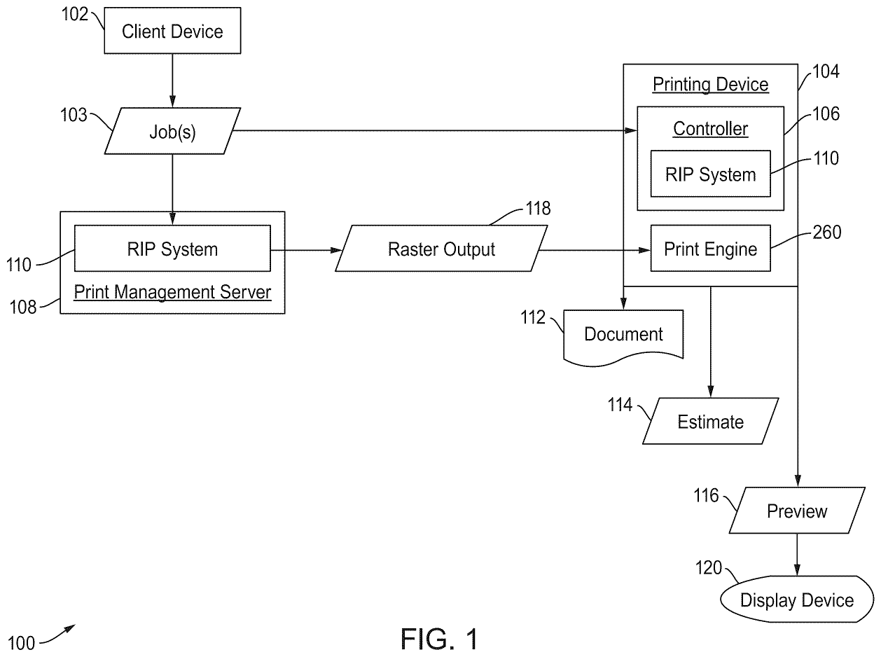

FIG. 1 depicts a printing system 100 for managing jobs using RIP system 110 according to the disclosed embodiments. Printing system 100 may be located in a print shop or other environment suitable for production printing operations. Printing system 100 includes one or more printing devices 104 that receive jobs 103 from one or more client terminals 102.

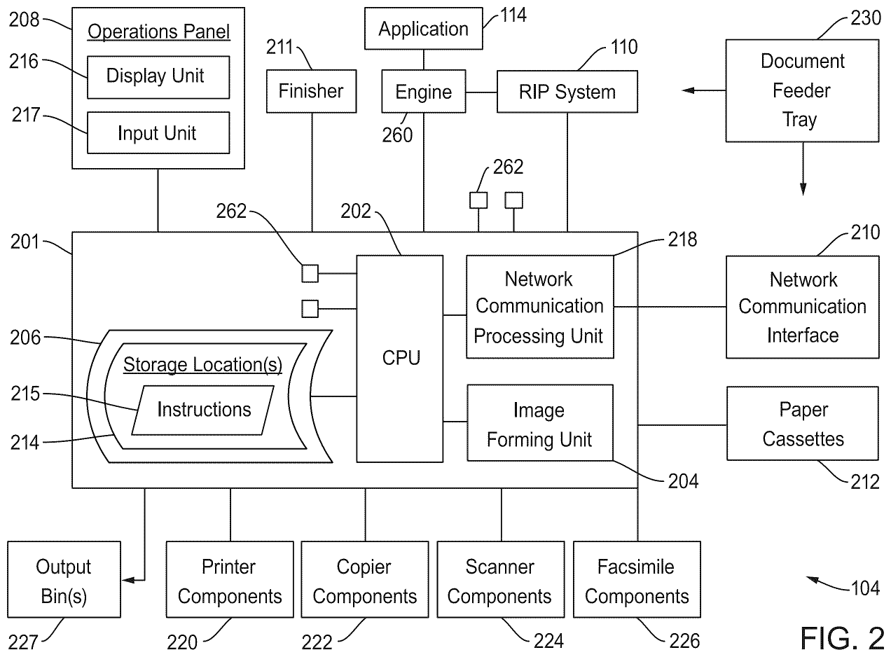

Printing device 104 receives jobs through printing system 100, such as job 103. In some embodiments, job 103 is a print job. After processing job 103, printing device 104 may print or produce document 112 in a paper or media specified by the print job. Printing device 104 is disclosed in greater detail in FIG. 2. Printing device 104 also includes a controller, or digital front end (DFE), 106, which facilitates processing job 103. Controller 106 also includes RIP system 110, which is disclosed in greater detail below.

For example, controller 106 may use RIP system 110 to convert bitmap images, vector graphics, fonts, and the like associated with pages in job 103 to bitmap/rasterized representations of the pages, such as C, M, Y, and K pixels. The sum of the values of pixels of a particular color in the rasterized pages may be proportional to the amount of consumables used by printing device 104 to print that color. RIP system 110 may rasterize pages of job 103 according to various image rasterization settings. For example, these image rasterization parameters may include calibration curves, paper definitions, ICC profiles, spot color definitions, TRCs, color conversion settings, colorant limits for ink or toner, rendering intent, K preservation, CGR level, max colorant densities, print margins, halftones, and the like.

Print engine 260 also is included with printing device 104. Printing device 104 may correspond to an industrial printing device capable of printing thousands of pages in an hour. Printing device 104 may be ink-based, toner-based, or both. Print engine 260 may include various parameters that can control the operation of printing device 104. For example, these settings may include printing device maintenance settings that control or effect head cleaning intervals, head clogging prevention intervals, and the like of printing device 104. Print engine 260 receives raster output from RIP system 110 in printing device 104 to print document 112 based on job 103.

Printing system 100 receives job 103 and may route it directly to printing device 104. Alternatively, printing system 100 may route job 103 to print management server 108. Print management server 108 may seek to offload processing of job 103 from controller 106 of printing device 104. This feature may be desirable if controller 106 does not have the processing capacity to handle jobs 103 in a production printing environment. Thus, print management server 108 also may include RIP system 110 that can provide raster output 118 directly to print engine 260 of printing device 104. These embodiments allow controller 106 to offload processing in order to handle other operations. Further, updates to RIP system 110 may occur at print management server 108 prior to any updates to RIP system 110 in printing device 104.

Job 103 is not always a print job that produces document 112. In some embodiments, job 103 may be an estimation job or a preview job. RIP system 110 determines which type of job is job 103 and configures itself accordingly. For an estimation job, RIP system 110 configures RIPs to process job 103 without impacting print processing within controller 106. The estimation RIPs process job 103 to provide an ink or toner estimate 114. Estimate 114 may be provided to an operator without engaging print engine 260.

For a preview job, RIP system 110 configures RIPs to process job 103 to quickly generate a lower resolution output as preview 116. Preview 116 may be a lower resolution output as compared to document 112 and estimate 114. Preview 116 is provided to the operator to review. Preview 116 may be provided to display device 120 for the operator to review and interact with using an interface. Display device 120 may be a separate device from client device 102 and printing device 104. In other embodiments, display device 120 may be incorporated within client device 102 or printing device 104.

As disclosed above, RIP system 110 may be a smart system that enables optimal processing by using page complexity determination to handle a variety of jobs 103. Different jobs received at printing device 104 or print management server 108 result in different output, such as document 112, estimate 114, or preview 116. The RIP instances within RIP system 110 are configured according to the type of job 103 is received.

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within printing system 100. As disclosed above, printing device 104 may send and receive data from client device 102, print management server 108, if a separate device, and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto printing device 104. The information for printing these papers may be captured in a paper catalog stored at controller 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from print management server 108. Display unit 216 may act as display device 120 for displaying preview 116 after it is generated by RIP system 110.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. RIP system 100 that interprets the page description languages (PDLs) would transmit and send instructions down to the lower-level engine 260 for actual rendering of an image and application of the ink onto paper during operations on printing device 104. RIP system 110 may be located in DFE 106, as disclosed above. Alternatively, RIP system 110 may be located on print management server 108 and directly communicates with print engine 260.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device.

Memory unit 206 may store the history of failure events and occurred errors with a timestamp of each error. Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from client device 102 and print management server 108 as well as other printing devices within printing system 100.

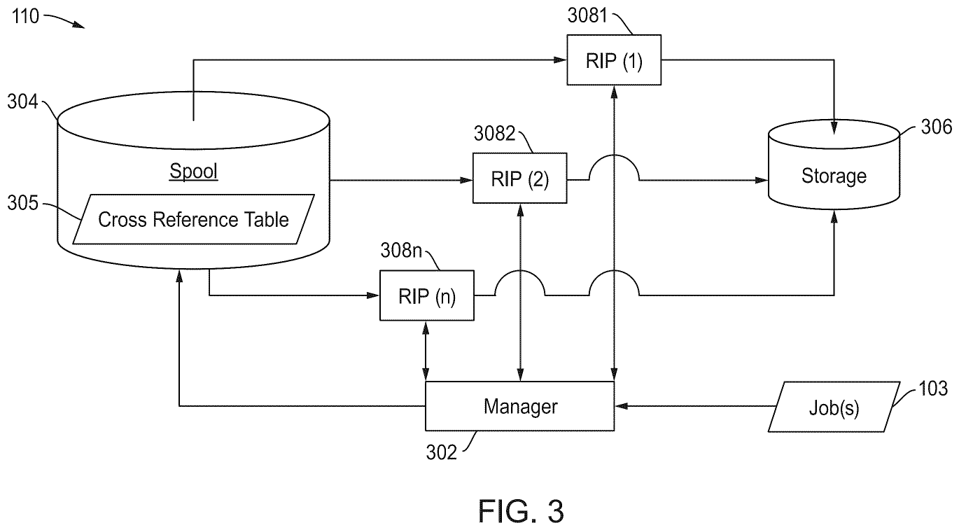

FIG. 3 depicts a block diagram of RIP system 110 for use in processing job 103 in printing system 100 according to the disclosed embodiments. As disclosed above, RIP system 110 may be located in controller 106 of printing device 104. It also may be located on print management server 108 such that it communicates directly with print engine 260 of printing device 104.

RIP system 100 includes RIP manager 302 and RIP instances RIP 3081, RIP 3082, and RIP 308n. A RIP instance may be a RIP configured by manager 302 to process job 103. A RIP instance may be a standard RIP, a high performance RIP, a very high performance RIP, a preview RIP, an estimation RIP, or a failover RIP. All RIP instances and manager 302 operate in parallel to each other.

Manager 302 performs a variety of operations. It may contain multiple subunits that operate in parallel to perform the variety of operations, like spooling job 103, managing job 103, managing pages or segments of job 103, managing RIP instances 3081, 3082, and 308n, managing drives, determining the PDL type of job 103, distributing pages of segments of job 103 to the RIP instances, serializing pages or segments of job 103, sending notifications within printing device 104 or print management server 108.

Manager 302 may receive job 103 through printing system 100. Job 103 may be received from client device 102 via internet protocols within printing system 100. Job 103 may be spooled by manager 302 and stored in spool drive 304. Spool drive 304 may be a configurable drive. Manager 302 determines the PDL type of job 103. It then creates a cross reference table 305 in spool drive 304, which acts as a shared memory with RIP instances 3081, 3082, and 308n. Manager 302 also may create print ticket information in spool drive 304.

Manager 302 analyzes job 103 to determine which type of job it is. It uses this information to determine the number of RIPs and type of RIPs to be used in processing job 103. These features are disclosed in greater detail below. Depending on the type of job, manager 302 configures RIP instances 3081, 3082, and 308n. A configuration operation may create a RIP having a certain number of renderers. For example, RIP instance 3081 may be a standard RIP having a normal number of renderers, such as 4. RIP instance 3082 may be a high performance RIP that has a higher number of renders, such as 6. Manager 302 configures the RIP instances accordingly to process job 103.

Manager 302 then distributes pages or segments of job 103 to RIP instances 3081, 3082, and 308n. Job 103 may be a print job that is split into segments or pages for parallel processing. As RIP instance 3082 is a high performance RIP, then it may receive specific pages or segments of job 103. Pages may refer to one or more pages of job 103. Segments of job 103 also may refer to a number of pages or a block of data within job 103. The pages or segments are distributed by manager 302 using inter-process communication.

RIP instances 3081, 3082, and 308n may read cross reference table 305 along with print ticket information and the spooled data for job 103. Each RIP instance then processes the page or segment that it is instructed to by manager 302. The RIP instance may check cross reference table 305 to obtain any instructions in the print ticket information and the data for the page or segment in spool drive 304. RIP instances 3081, 3082, and 308n then parse the data for the page or segment to create metadata from the drawing commands.

The RIP instances render the metadata to storage 306. Storage 306 may store the rendered pages for a print job of job 103. The rendered pages may be stored according to a specific image format, such as the KYOCERA™ Image Format (KIF). The stored pages may then be provided to print engine 260 to print document 112. For jobs 103 that do not require rendered pages, such as previews and estimates, the data generated by the RIP instances may be provided back to manager 302 for further operations.

RIP system 110 provides advantages over conventional RIP systems. Manager 302 may control the number of renderers per RIP. It may increase the number to process a page or segment faster. It also may increase the amount of memory allocated to the RIP as faster processing consumes more memory. If processing is to be slower, such as for estimate 114 or preview 116, then the configured RIP should consume less memory. Manager 302 manages these requirements through dynamic configuration of the RIPs based on the parameter of job 103.

In some instances, manager 302 may determine that job 103 is not able to be split into pages or segments for parallel processing. Thus, it may configure a RIP instance, such as RIP instance 308n, into a very high performance RIP. The very high performance RIP uses more renderers than the high performance RIP. For example, RIP instances 308n may be configured to use 8 renderers. This feature increases the processing speed of RIP instance 308n. Manager 302 may still use RIP instances 3081 and 3082 for parallel processing on one job 103 while using RIP instance 308n for processing another job 103 that is not able to be broken into pages or segments.

RIP system 110 provides features available due to the parallel processing using dynamically configured RIP instances. RIP system 110 may configure a high performance RIP to improve the first page out time. It also may use differently configured RIPs for different purposes, such a preview RIPs, estimation RIPs, and failover RIPs. RIP system 110 also may configure very high performance RIPs for jobs that cannot be processed in a page or segment parallel manner.

RIP system 110 also provides the ability to change the number of renderers per RIP. RIP system 110 also changes the number of RIP instances based on its workload, which includes shutting down certain types of RIPs in order to launch other types of RIPs. RIP system 100 also processes different kinds of jobs in RIPs with different configurations. RIP system 110 also uses different RIPs with different configurations for different purposes. It configures RIP instances with different imaging pipelines. RIP system 110 also retries failed jobs or job pages in a differently configured RIP instance.

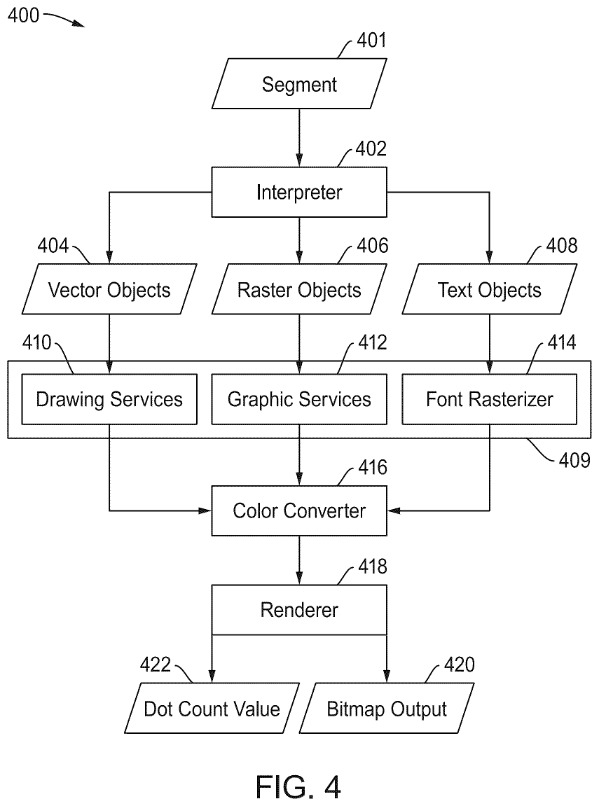

FIG. 4 depicts a block diagram of an example RIP 400 used within RIP system 110 according to the disclosed embodiments. RIP 400 may represent a configuration for RIP instances 3081, 3082, or 308n. RIP 400 may represent the hardware and software configurations used to determine what value each pixel or spot of output should possess, driven by commands from a page description language (PDL). Computer-generated output may be composed of very small spots. RIP 400 converts a vector-based image, or a stored image, into a series of mathematical formulas that describe lines and curves into a pattern of spots needed to generate the output, or raster image. Interpreter 402 converts a job file into a display list, which is then converted into a bitmap output 418 describing a page of the document.

RIP 400 converts text and image data from different file formats including PDF, TIFF, or JPEG into a format that printing device 104 can understand. The process of raster image processing a page implements several steps to be performed, regardless whether the page is submitted as PostScript, PDF, or any other page description language (PDL). In short, RIP 400 may provide interpretation, rasterization, and screening.

Segment 401 may be a job file associated with job 103. Segment 401 may be provided to RIP 400 to convert its code into raster or bitmap code. As disclosed above, manager 302 receives job 103. Manager 302 may split job 103 into segments for parallel processing by the RIP instances. Preferably, segment 401 is a page the document in job 103. RIPs process pages in a parallel manner within RIP system 100. RIP 400 is one of the RIP instances. In other embodiments, segment 401 may be several pages, a graphic design, or other portion of job 103.

Segment 401 is received at interpreter 402, which interprets the commands in the code to redraw the object and elements of a page as vector objects 404, raster objects 406, and text objects 408. Interpreter 402 parses specific PDLs into drawing commands. The PDL of segment 401 is read and decoded into graphical elements to be placed on a sheet. Each element may be an image, a character of text, a fill, stroke, and the like or listed in vector objects 404, raster objects 406, and text objects 408.

Drawing unit 409 receives vector objects 404, raster objects 406, and text objects 408 to convert the drawing commands into metadata that can be provided to renderer 418. Thus, drawing unit 409 converts vector objects 404 into drawing services 410. It also converts raster objects 406 into graphic services 412. It also converts text objects into font rasterizer 414.

RIP 400 also may implement color converter 416. Color converter 416 may implement color conversion operations for the metadata generated by drawing unit 409. Color converter 416 provides color management and calibration. These actions may be applied during interpretation or rendering, depending on configuration and job content. Color printing resources may be accessed to provide the color management.

Renderer 418 processes the metadata from drawing unit 409 to convert every graphical element into the appropriate pattern of pixels to form the output raster. The resolution independent vector objects 404 as drawing services 410 are converted into pixels. Screening takes the raster image of pixels to form individually screened cyan, magenta, yellow, and black separations. These are halftone dots in the form of a bitmap output 420 consisting of commands that can be understood by print engine 260.

The disclosed embodiments also may determine dot count value 422 from the rendered image provided by renderer 418. Dot count values may be adjusted based on screening and based on settings at printing device 104. Dot count value 422 may be reported to determine estimate 114 for an estimation job, as disclosed below.

The rendered bitmap output 420 may be stored in storage 306 to be sent to print engine 260 when all the pages or segments of job 103 are processed. RIP 400 shows one path for rendering and providing output. Preferably, RIP 400 multiple rendering paths that use multiple renderers. The disclosed embodiments may use a renderer 418 for each channel in RIP 400, such as one each for cyan, magenta, yellow, and black. The number of renderers 418 may be configured by manager 302 depending on job 103. Each renderer 418 requires memory and processing resources. A high number of renderers 418 in RIP 400 will consume more memory but run faster. A lower number of renderers 418 in RIP 400 will consume less memory but run slower.

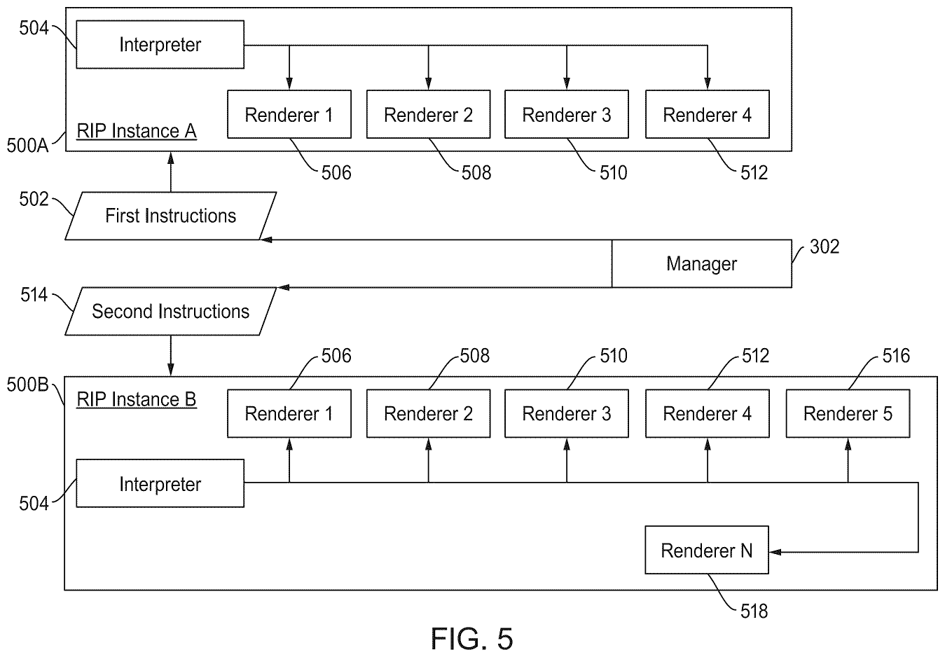

FIG. 5 depicts a block diagram of manager 302 of RIP system 110 configuring a RIP instance 500A according to the disclosed embodiments. Manager 302 may send instructions to RIP instances to change their configuration in response to a need for different RIPs within RIP system 110. These changes may include increasing the number of renderers within the RIP, decreasing the number of renderers within the RIP, changing the type for RIP, and the like. This feature enables RIP system 100 to be configurable to meet the processing requirements for different jobs.

Manager 302 may send first instruction 502 to RIP instance 500A. RIP instance 500 may correspond to RIP 400, as disclosed above. The features of RIP 400 are not repeated here for brevity. RIP instance 500A may be considered a standard RIP that includes interpreter 504 along with renderer 1 506, renderer 2 508, renderer 3 510, and renderer 4 512. Renderers 506-512 may operate to perform functions in processing a print job, providing a preview, or providing an estimate.

First instruction 502 may instruct RIP instance 500A to modify its configuration to meet a current need within RIP system 110. For example, manager 302 may determine that RIP instance 500A needs to reconfigure itself to be a high performance RIP. First instruction 502 includes instructions to increase the number of renderers within RIP instance 500A to become a high performance RIP. The disclosed embodiments execute an operation to reconfigure RIP instance 500A into RIP instance 500B.

After operation 520 is completed, RIP instance 500B includes interpreter 504 along with an increased number of renderers. The increased number of renderers provide RIP instance 500B with increased processing capability but also takes up more memory and resources to accommodate the increased number of renderers. Thus, RIP instance 500B includes renderer 1 506, renderer 2 508, renderer 3 510, renderer 4 512, renderer 5 516, and renderer N 518. Renderer N 518 may be the last renderer implemented in RIP instance 500B. In some embodiments, renderer N 518 may be the sixth renderer. In other embodiments, renderer N 518 may be the eighth renderer such that renderers 6 and 7 also are included in RIP instance 500B, but not shown. RIP instance 500B now includes two or more additional renderers to perform processing of a print job, page, segment, and the like.

Manager 302 may receive another job 103 that requires RIP instance 500B to be reconfigured back to a standard RIP. Second instruction 514 is received at RIP instance 500B. Another operation is executed as a result to reconfigure RIP instance 500B back to four renderers. Processing capability may be reduced, but less memory and resources will be needed. Thus, manager 302 may dynamically configure the RIP instances to become different RIPs, as needed based on job requirements, as well as other factors such as page complexity and available resources.

First instruction 502 also may instruct RIP instance 500A to configure into a preview RIP. This configuration would use the same resources of a standard RIP, so the number of renderers would remain the same. For example, if RIP instance 500A includes 4 renderers then the preview RIP would include 4 renderers. If RIP instance 500A includes 6 renderers then the preview RIP also would include 6 renderers. RIP instance 500A, however, would be configured to generate a lower resolution output.

First instruction 502 also may instruct RIP instance 500A to configure into an estimation RIP. This configuration may reduce the number of renderers, even for a standard RIP. Estimation RIPs use reduced memory allocation. Thus, if RIP instance 500A includes 6renderers, then it may be reconfigured to have 4 renderers. In some embodiments, the number of renderers may be reduced from 4 to 2.

The disclosed embodiments may configure RIP instance 500A to include any number of renderers. The number of renderers depends on the processing capability needed for job 103, page complexity, and available memory resources. The more renderers, however, then the more memory and resources need to be allocated for the RIP instance. Thus, RIP system 110 may not want a large number of high performance or very high performance RIPs running all the time. Manager 302 dynamically configures RIP system 110 to meet the processing requirements for the received job, whether it is a print job, estimation job, or preview job.

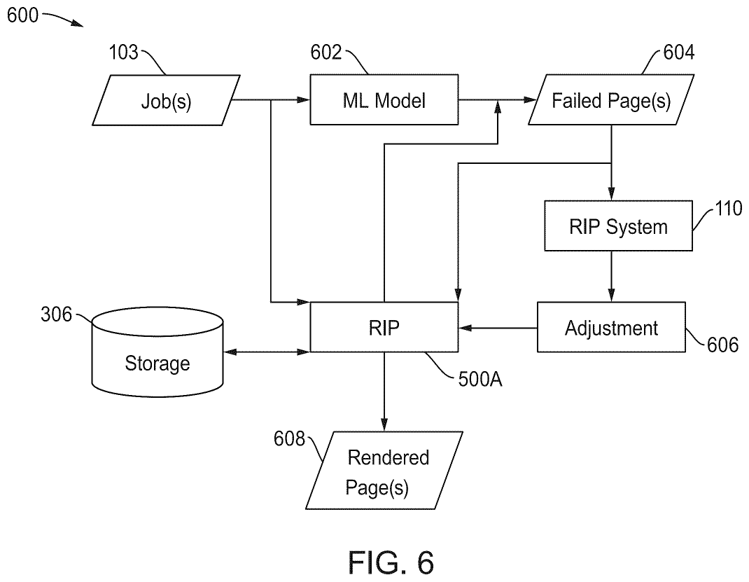

FIG. 6 depicts a block diagram of a process flow 600 for adjusting a RIP 500A to render job 103 according to the disclosed embodiments. Process flow 600 includes elements of the figures disclosed above. Reference may be made to these elements, but process flow 600 is not limited to the embodiments disclosed above. Job 103 may be received within printing system 100 and provided to RIP system 110 for rendering. As disclosed above, RIP system 100 may assign job 103, or pages of job 103, to one or more RIPs. Process flow 600 shows RIP 500A, which may be a standard RIP as disclosed above.

During rendering operations, job 103 may fail due to insufficient memory in storage 306. As disclosed above, manager 302 may reconfigure an existing RIP to accommodate job 103. Alternatively, RIP system 110 may implement an adjustment 606 that provides a fallback mechanism to be applied to one or more failed pages 604 that failed to render. RIP system 110 may implement adjustment 606 to the rendering process as opposed to reconfiguring and relaunching RIPs. Failed pages 604 are resubmitted for rendering to RIP 500A but are specified to process in a manner that requires less memory within storage 306.

After failed pages 604 are determined, adjustment 606 is made to the process used by RIP 500A so that it may stay configured as a standard RIP and yet still render the failed pages without the need for additional memory in storage 306. For example, if memory is available in storage 306, then RIP system 110 may reconfigure RIP 500A into a high performance RIP, as disclosed above. If memory is not available, then this option may not be available. Process flow 600 resolves this situation to render failed pages 604 without the need for additional memory.

After adjustment 606 is implemented, failed pages 604 are resubmitted to RIP 500A. In some embodiments, job 103 may be resubmitted. Using adjustment 606, RIP 500A should be able to process the failed pages to generate one or more rendered pages 608 based on failed pages 604. Rendered pages 608 may be provided to print engine 260 for printing, if required for job 103.

Different embodiments regarding adjustment 606 are disclosed below. Various operations may be performed to reduce the memory needed to process failed pages 604. In some embodiments, a preflight operation is performed on job 103 to determine whether adjustment 606 should be done before attempting to render a page of the job. In other words, adjustment 606 may be determined and implemented before any rendering by RIP 500A. This feature may save processing time and failed attempts to render jobs 103 requiring more memory than is available.

The disclosed embodiments may apply machine learning model 602 to job 103 to determine whether any adjustments 606 should be implemented in processing job 103 using RIP 500A. Model 602 may be trained to determine when job 103 may exceed memory availability in being rendered by RIP 500A. Model 602 also is continually trained based on rendering failures and subsequent successes after adjustments 606. This process also may provide a model 602 that can determine or predict which settings to change in the rendering process, but also how much the settings or adjustments 606 should be adjusted. These features are disclosed in greater detail below.

As shown in FIG. 6, after applying adjustment 606, RIP system 110 would render failed pages 604 or job 103 a second time. RIP system 100 may perform modest changes to the resolution and flatness settings for job 103 in order to preserve as much of the expected appearance as possible. If rendering of failed pages 604 or job 103 occurs a second time, then RIP system 110 may implement another adjustment 606 having more drastic changes, such as increasing a setting to adjust the processing. These features are disclosed in greater detail below. RIP system 100 may reattempt processing job 103 or failed pages 604 until it is rendered. In some embodiments, an upper limit may be defined for any settings. If this limit is reached, then rendering operations may switch over to reconfiguring RIP 500A.

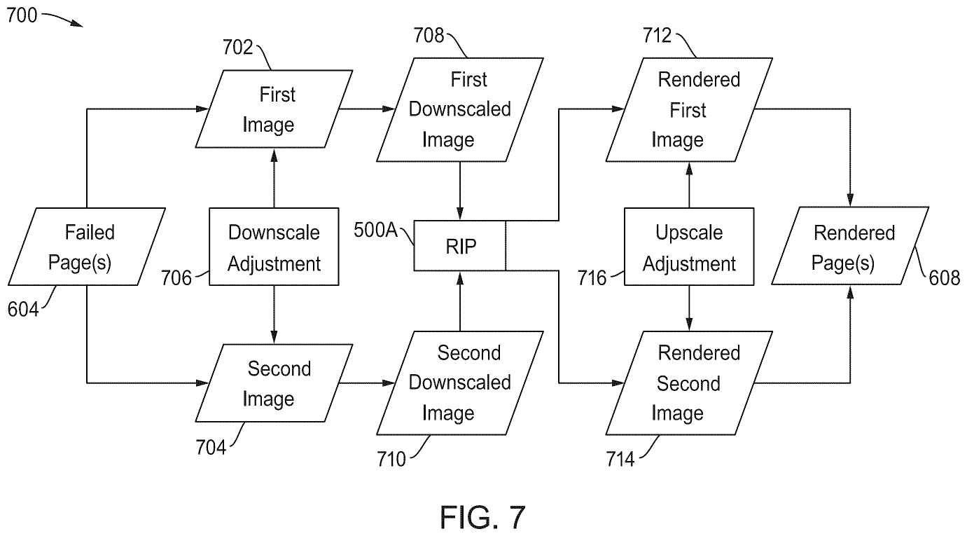

FIG. 7 depicts a flow diagram 700 for adjusting processing of images in one or more failed pages 604 as an adjustment 606 according to the disclosed embodiments. In some embodiments, adjustment 606 may downscale images before they are rendered. Alternatively, the images may be rendered at a lower resolution as opposed to the rest of job 103.

Thus, the disclosed embodiments may identify a first image 702 and a second image 704 in failed pages 604. In some embodiments, multiple images may be identified. Alternatively, only first image 702 or second image 704 may be identified. These images may result in too much memory being required to process failed pages 604. RIP system 110 applies a downscale adjustment 706 as adjustment 606 to first image 702 and second image 704. Downscale adjustment 706 performs downscaling on the images, or decreases the resolution of first image 702 and second image 704 by reducing the number of pixels in the images. Downscaling should result in a smaller file size for the images.

After downscale adjustment 706 is applied, first downscaled image 708 is generated for first image 702 and second downscaled image 710 is generated for second image 704. First downscaled image 708 has a smaller file size than first image 702. Second downscaled image 710 has a smaller file size than second image 704. Thus, the memory requirements to render the downscaled images should not be as high as for the images in failed pages 604. For example, first image 702 may have a file size of 2 MB and second image 704 may have a file size of 3 MB. RIP system 110 may not be able to render file size greater than 4 MB without failing. Thus, downscale adjustment 706 may reduce the file sizes for each image. First downscaled image 708 may have a file size of 1 MB and second downscaled image 710 may have a file size of 1.5 MB. The combined memory of the downscaled image may be 2.5 MB, which is below the 4 MB limit. First downscaled image 708 and second downscaled image 710 may be rendered at speed.

In some embodiments, only one of first image 702 and second image 704 are downscaled. For example, RIP system 110 may apply a threshold size, such as 1 MB, to identify an image for downscale adjustment 706. Images below the threshold are not downscaled. If first image 702 has a file size of 1.2 MB and second image 704 has a file size of 0.6 MB, then downscale adjustment 706 is applied to first image 702 and not to second image 704. First downscaled image 708 and second image 710 are provided to RIP 500A. In other embodiments, downscale adjustment 706 may be applied after a specified number of images is reached. For example, those images identified after the number is reached are subject to downscale adjustment 706. In summary, RIP system 110 may be configured to select different images to downscale as needed so that not every image is downscaled prior to rendering operations.

RIP 500A may generated rendered first image 712 and rendered second image 714 based on first downscaled image 708 and second downscaled image 710, respectively. RIP system 110 then applies upscale adjustment 716 to increase the number of pixels in the images or increase the resolution of the images. The upscaled images are then placed back into rendered pages 608, which may have been rendered normally without any adjustments. Rendered pages 608 along with the rendered images may be sent to print engine 260, if needed.

In some embodiments, RIP system 110 may implement rendering first image 702 and second image 704 at a lower resolution than other objects in failed pages 604. Thus, adjustment 606 is applied if one or more images are at a resolution higher than a threshold. If so, then adjustment 606 instructs RIP 500A to render at a lower resolution than the rest of job 103. This feature may reduce the memory size requirements for rendering job 103. The resolution of the images may be increased after rendering.

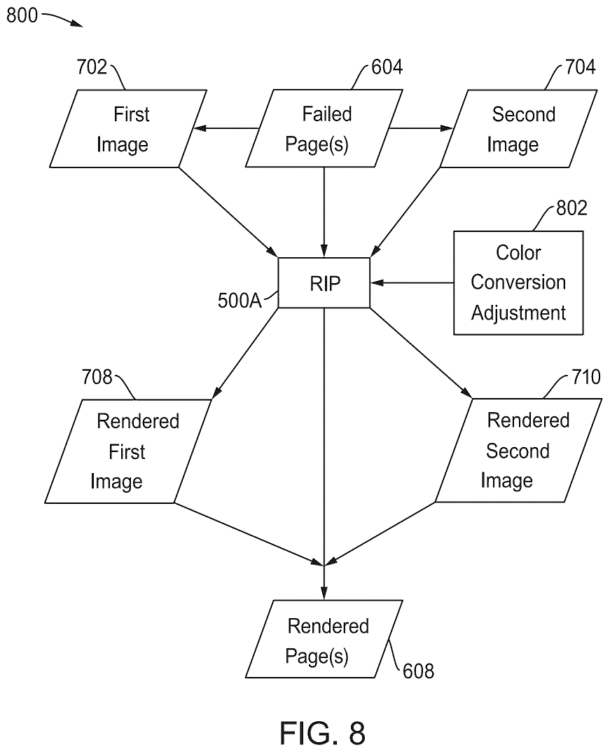

FIG. 8 depicts a flow diagram 800 for adjusting the processing of the color conversion of one or more failed pages 604 as an adjustment 606 according to the disclosed embodiments. In some embodiments, color conversion may be changed from a two-step color conversion into a one-step color conversion. A two-step color conversion may be one in which colors of one or more images within job 103 or failed pages 604 are converted from source to the profile connection space (PCS). The colors then are converted from the PCS to a destination, such as print engine 260. These color conversions may involve two separate operations in performing the conversions, which may require an amount of memory in storage 306 not available to RIP 500A.

Color conversion adjustment 802 may implement a one-step color conversion process. The two-step color conversion processes may be merged into the one-step process. Thus, the one-step color conversion may be from source to destination. Data regarding colors within the images may be mapped to data to be used by the destination in printing or presenting the rendered color image. These processes may use ICC profiles that have the processes in mapping to the ICC profiles merged into one step. The change may impact color reproduction quality, especially if there are discontinuities in the ICC profiles. The one-step color conversion process uses less memory than the two-step color conversion process as it is only one processing step.

For example, first image 702 and second image 704 may be identified from failed pages 604, as disclosed above. In some embodiments, first image 702 and second image 704 may be a first color and a second color, respectively. In other words, these features may refer to one or more colors within failed pages 604. The disclosed embodiments, however, will refer to first image 702 and second image 704 for brevity.

Identification of first image 702 and second image 704 may be determined in a variety of ways. For example, one or more images having a large file size or a high resolution may be identified for color conversion using color conversion adjustment 802. In some embodiments, images over 1 MB may be subject to color conversion adjustment 802 using RIP 500A. Alternatively, color conversion adjustment 802 may be applied if there are a number of images above a threshold. For example, if the number of images is greater than 5, then RIP system 110 will apply color conversion adjustment 802 for rendering failed pages 604 or job 103 using RIP 500A.

Using the one-step color conversion implemented by color conversion adjustment 802, RIP 500A generates rendered first image 712 and rendered second image 714 as disclosed above. Rendered first image 712 and rendered second image 714 are included in rendered pages 608 for job 103. In some embodiments, only one of first image 702 and second image 704 are subject to color conversion adjustment 802 so that one of rendered first image 712 or rendered second image 714 is rendered using the one-step color conversion that affects color reproduction quality.

Various processes may be implemented to limit the number of images subject to color conversion adjustment 802 because image reproduction quality may be reduced. The processing memory requirements, however, are reduced so that RIP 500A can render the images without failing. RIP system 110 may remove color conversion adjustment 802 after job 103 is rendered so that subsequent jobs use the two-step color conversion for better reproduction quality.

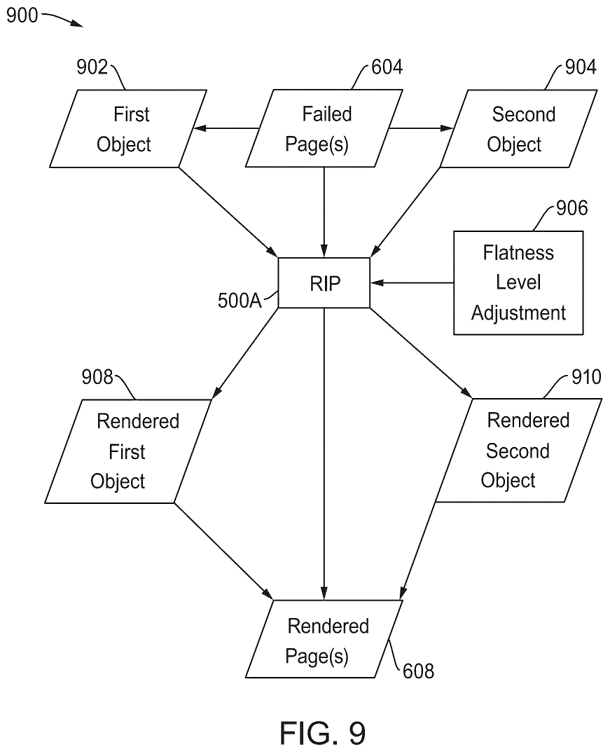

FIG. 9 depicts a flow diagram 900 for adjusting the vector level flatness used in processing of one or more failed pages 604 as an adjustment 606 according to the disclosed embodiments. In some embodiments, flatness level adjustment 906 may be implemented as adjustment 606 by RIP 500A in rendering one or more failed pages 604. The vector flatness level may be increased which changes how many straight lines are used to render a curve within an object or image of job 103. RIPs may render with many short lines in order to render curves with a good appearance when reproduced. Flatness level adjustment 906 increases flatness, which reduces the number of lines used to render the curves. This feature may degrade appearance but reduces memory requirements for RIP 500A.

Thus, first object 902 and second object 904 may be identified from one or more failed pages 604. More than these objects may be identified and maybe only one object is identified. First object 902 and second object 904 may differ from images in that these may be graphics in job 103 that require rendering using the lines as opposed to color conversion. First object 902 and second object 904, however, may be found within one or more images.

If the memory requirements to render first object 902 and second object 904 result in failure at RIP 500A, then RIP system 110 may apply flatness level adjustment 906. Flatness level adjustment 906 causes RIP 500A to use longer lines to render the objects. Less lines will be used to render the objects, which reduces the memory requirements for RIP 500A. For example, normal rendering may use lines having a length of three pixels. Flatness level adjustment 906 may increase the flatness level to six pixels so that the lines are longer. The appearance of a curve may not be as accurate but the amount of memory needed to implement the longer lines is reduced.

The rest of failed pages 604 may be rendered as normal by RIP 500A. First object 902 and second object 904 are rendered using flatness level adjustment 906 by RIP 500A. Thus, RIP 500A may now render job 103, including any failed pages 904. RIP 500A generates rendered first object 908 based on first object 902 and rendered second object 910 based on second object 904 using flatness level adjustment 906. The rest of failed pages 604 are rendered into rendered pages 608. Rendered first object 908 and rendered second object 910 then are included in rendered pages 608.

The disclosed embodiments apply one or more adjustments 606 during the rendering process at RIP 500A to reduce memory requirements within RIP system 110. This feature may be implemented instead of reconfiguring RIP 500A or providing additional memory resources to the rendering operations for job 103.

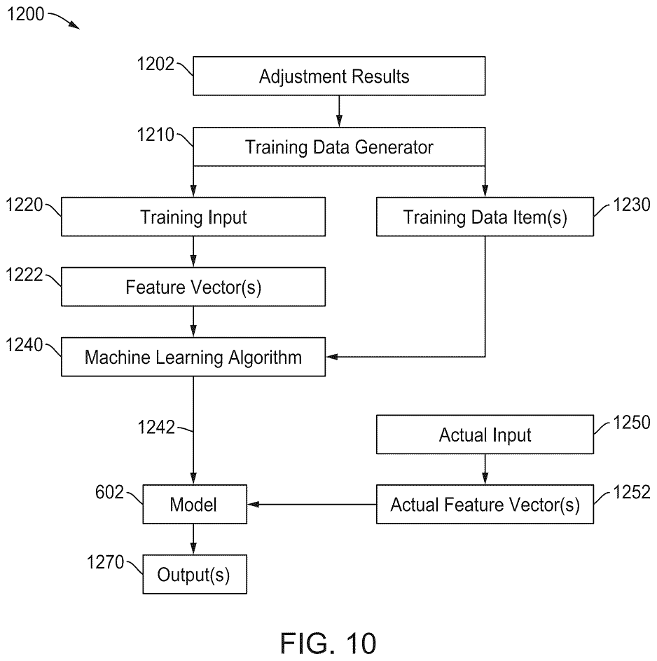

FIG. 10 depicts a block diagram of a supervised learning pipeline 1200 for a machine learning model 602 to determine an adjustment 606 to be implemented by RIP system 110 according to the disclosed embodiments. Model 602 may pertain to a model trained to determine whether an adjustment 606 should be implemented in RIP 500A to render job 103. Model 602 is generated and trained using supervised learning pipeline 1200. Model 602 may forgo the need to have pages fail during the rendering of job 103 before implementing any adjustment 606.

Supervised learning pipeline 1200 includes training data generator 1210, training input 1220, one or more feature vectors 1222, one or more training data items 1230, machining learning algorithm 1240, actual input 1250, one or more actual feature vectors 1252, model 602, and one or more predictive date field outputs 1270. Part or all of supervised learning pipeline 1200 may be implemented by executing software for part or all of supervised learning pipeline 1200. These operations may occur within controller 106 of printing device 104. They also may occur elsewhere within printing system 100, such as print management server 108.

In operation, supervised learning pipeline 1200 may involve two phases: a training phase and a prediction phase. The training phase may involve machine learning algorithm 1240 learning one or more tasks related to selecting an adjustment 606 to apply to RIP 500A for rendering failed pages 604. The prediction phase may include model 602, which is a trained version of machine learning algorithm 1240 and makes predictions to accomplish one or more tasks for determining features along with probability scores for adjustments to select. In some embodiments, machine learning algorithm 1240 or model 602 may include one or more artificial neural networks (ANNs), deep neural networks, convolutional neural networks (CNNs), recurrent neural networks, support vector machines (SVMs), Bayesian networks, genetic algorithms, linear classifiers, non-linear classifiers, algorithms based on kernel methods, logistic regression algorithms, linear discriminant analysis algorithms, or principal components analysis algorithms.

During the application of adjustments 606 in rendering jobs 103, controller 106 or server 108 may capture the results in generating rendered pages 608, including whether the rendering process is still failing due to memory requirements to perform the operations. These results may be known as adjustment results 1202 compiled within printing system 100. Effectiveness of the different adjustments may be captured. The effectiveness of an adjustment may be determined by comparing whether the rendering process using RIP 500A is successful. This information may be used as training input 1220 by supervised learning pipeline 1200.

During the training phase of supervised learning pipeline 1200, training data generator 1210 may generate training input 1220 and training data item(s) 1230 using adjustment results 1202. Training input 1220 may be processed to determine one or more feature vectors 1222 based on adjustment results 1202. In some embodiments, training input 1220 may be preprocessed. For example, for each result of an adjustment 606 applied to a failed page 604, training input 1220 may be preprocessed to the effectiveness in reducing processing requirements for the complex page. The tables, factors, scores, attributes, strategies, results, and the like may be used as part of training input 1220. In some embodiments, training data generator 1210 is not used to generate training input 1220 or training data items(s) but adjustment results 1202 are provided directly as feature vectors 1222.

Feature vector(s) 1222 may be provided to machine learning algorithm 1240 to learn one or more tasks for selecting an adjustment to be implemented by RIP 500A for a job 103 being rendered by RIP system 110. After performing the one or more tasks, machine learning algorithm 1240 may generate one or more outputs 1242 based on feature vector(s) 1222 and, optionally, training data items 1230. Output 1242 may be a prediction or score of which adjustment 606, if any, to implement.

During training, training data items 1230 may be used to make an assessment of the outputs 1242 of machine learning algorithm 1240 for accuracy. Machine learning algorithm 1240 may be updated based on this assessment. Training of machine learning algorithm 1240 is considered to be trained to perform the one or more tasks for providing a probability for an adjustment operation to be applied. Once trained, machine learning algorithm 1240 may be used to generate model 602. In other words, model 602 may be generated from the training of machine learning algorithm 1240. In some embodiments, machine learning algorithm 1240 also is known as a model.

During the prediction phase of supervised learning pipeline 1200, actual input 1250 may be used to generate one or more actual feature vectors 1252. In some embodiments, some of all of actual input 1250 includes one or more forms of data disclosed above. Actual input 1250 may be provided to model 602 via actual feature vector(s) 1252. Model 602 may generate one or more outputs, such as predictions or probabilities, based on actual input 1250. The outputs of model 602 may be provided as outputs 1270. Outputs 1270 are used to select an adjustment 606 to implement using RIP 500A. Actual input 1250 may be based on a new job 103 being processed by model 602 that is then used to determine whether an adjustment 606 may be needed to render job 103 and which adjustment to implement.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing printing operations, the method comprising:
receiving a job at a raster image processing (RIP) system;
determining the job fails during a rendering operation at the RIP system due to insufficient memory available to the RIP system;
downscaling at least one image within the job;
adjusting the job based on the downscaled at least one image;
rendering the job at the RIP system; and
upscaling the at least one image within the job.

2. The method of claim 1, further comprising rendering the at least one image at a lower resolution than another object within the job.

3. The method of claim 1, wherein the job includes a job file having a file size.

4. The method of claim 3, wherein the downscaling reduces the file size of the job file.

5. The method of claim 1, wherein determining the job fails includes determining that a page within the job fails during the rendering operation at the RIP system.

6. The method of claim 5, wherein downscaling the at least one image includes downscaling the at least one image in the page.

7. The method of claim 1, further comprising sending the rendered job with the upscaled at least one image to a print engine of the printing device.

8. The method of claim 1, wherein determining the job fails during the rendering operation includes applying a trained machine learning model to the job to determine whether the job will fail to render.

9. A method for managing printing operations, the method comprising:
receiving a job at a raster image processing (RIP) system;
determining the job fails during a rendering operation at the RIP system;
modifying a color conversion process within at least one RIP of the RIP system for at least one image within the job, wherein the modified color conversion process uses a reduced amount of a memory available to the RIP system; and
rendering the job with the at least one RIP using the modified color conversion process.

10. The method of claim 9, wherein determining the job fails during the rendering operation includes applying a trained machine learning model to the job to determine whether the job will fail to render.

11. The method of claim 9, further comprising determining that the at least one image is above a specified data size or above a specified resolution.

12. The method of claim 11, further comprising determining that at least one smaller image is below the specified data size or below the specified resolution, wherein the at least one smaller image is not rendered using the modified color conversion process.

13. The method of claim 9, further comprising determining that a number of the at least one image is above a specified amount.

14. The method of claim 9, wherein the modified color conversion process is a one-step color conversion process.

15. A method for managing printing operations, the method comprising:
receiving a job at a raster image processing (RIP) system;
determining the job fails during a rendering operation at the RIP system;
increasing a vector flatness level within at least one RIP of the RIP system for at least one image within the job, wherein the increased vector flatness level uses a reduced amount of a memory available to the RIP system; and
rendering the job with the at least one RIP using the increased vector flatness level.

16. The method of claim 15, wherein determining the job fails during the rendering operation includes applying a trained machine learning model to the job to determine whether the job will fail to render.

17. The method of claim 15, wherein the increased vector flatness level reduces the number of lines to render an image within the job.

18. The method of claim 15, further comprising determining that at least one image of the job is above a specified data size or above a specified resolution.

19. The method of claim 15, further comprising, if the job fails to render using the increased vector flatness level, further increasing the vector flatness level.

20. The method of claim 15, further comprising sending the rendered job to a print engine of the printing device.
